(19) United States
(12) Patent Application Publication
(10) Pub. No.: US 2022/0027835 A1
(43) Pub. Date: Jan. 27, 2022

(54) THIRD PARTY VALIDATION SYSTEM AND METHOD FOR REMOTELY DETERMINING COMPLIANCE WITH PROTOCOLS

(71) Applicant: R5 Labs, LLC, San Francisco, CA (US)

(72) Inventor: Leonardo Rocco, San Francisco, CA (US)

(21) Appl. No.: 17/382,091

(22) Filed: Jul. 21, 2021

Related U.S. Application Data
(60) Provisional application No. 63/054,944, filed on Jul. 22, 2020.

(51) Int. Cl. G06Q 10/06

(52) U.S. Cl. CPC G06Q 10/063114; G06T 2207/30232; G06Q 10/0639

(57) ABSTRACT

A system may include a server, which may present on a user device operated by a user via a software application running on the user device, one or more tasks to be executed in a designated physical location. The server may receive from the user device via the software application, a set of images of the designated physical location upon execution of the one or more tasks. The server may execute an artificial intelligence model to process the set of images to determine whether the one or more tasks are successfully completed. In response to determining that the one or more tasks are successfully completed, the server may transmit a notification to a smart display device within the designated physical location. The smart display device is configured to present the notification.

### REFERENCE TO THE RELATED PATENT APPLICATION

The present application claims benefit of U.S. provisional application No. 63/054,944 filed on Jul. 22, 2020.

### TECHNICAL FIELD

The subject matter described herein relates to third party validation systems and methods, particularly for ensuring compliance with guidelines and protocols, including health and safety guidelines.

### BACKGROUND

Third party verification and validation of a person or entity's compliance with guidelines and protocols (safety, maintenance, cleanliness, financial, etc.) is critical for business owners, customers, employees, and government officials. Establishing and continually increasing credibility, whether it relates to compliance with a company's maintenance schedule for a vehicle or with the USDA's requirements for certified organic, is essential for all professionals and businesses.

As a manager, instituting new protocols, especially when they have not been used before, either by the entity or individual, is very difficult. However, for companies to grow and deliver results, especially in today's increasing gig economy (e.g., a labor market characterized by the prevalence of short-term contracts or freelance work as opposed to permanent jobs), it is important to create protocols and ensure consistent compliance in order to consistently deliver quality goods or services. Companies that turn to the gig economy for third-party services (e.g., cleaning, delivery, maintenance, etc.) to save money on labor costs or fill talent gap, might end up damaging their brands and/or worse (exposing to legal liabilities) because these worker(s) may take short cuts, not care much about cultivating relationships with customers, and/or not do the job right.

Companies with high morale have a much higher employee retention rate since employees value their jobs and look forward to work, e.g., studies consistently show that it costs businesses between 30% to 50% of an annual salary to replace an entry-level employee. Making protocols accessible, understandable, and stronger through reward and recognition programs are ways that better ensure compliance with policies and procedures without lowering morale.

For example, in a post-pandemic era where uncertainty abounds, third party validation of cleaning and disinfection methods to ensure compliance is critical to business owners, customers, employees, and government officials. The process of cleaning may include many operational steps and variables, which may differ based on industry (healthcare, manufacturing, office, retail, hospitality, restaurant, etc.)

Before, a person might walk into a room, verify that it looked and smelled clean—and hope that it was cleaned. Or approach an employee, housekeeper, etc. and ask if he/she is done cleaning. Maybe take swabs and then sign off on compliance.

For example, one approach is for a company to compile a checklist (physical and/or digital) of cleaning tasks being filled-out by the cleaning staff, employee, and/or inspection staff after the predefined area is cleaned. The filled-out checklist is evaluated independently or in combination with various inputs (e.g., comments from the staff or the customer, etc.) based on physical inspections of the cleaned predefined area to assess the cleaning quality. The filled-out checklist is subject to errors due to lack of uniform understanding of cleaning quality, etc. Additionally, the physical inspections may be unreliable due to bias or human error, time-consuming, and cost intensive. Further, having a supervisor shadow employee(s) during work often lowers employee morale.

Another approach is for a company to invest in expensive hardware (e.g., RFID beacons installed throughout facility). However, hardware intensive solutions fail to determine the quality of cleaning performed at various points or whether the cleaning quality meets the cleaning standards without the physical inspections. They also introduce privacy concerns and fail to address the need for independent third-party verification.

Today, modern handheld mobile devices, such as smartphones, are equipped with significant processing power, sophisticated multi-tasking operating systems, high-bandwidth Internet connection capabilities, GPS, high-resolution cameras and video cameras, microphones, and accelerometers. As the capabilities of mobile devices have increased, so too have the applications (i.e., software) that can be used with mobile devices, including payment and rewards mechanisms.

### SUMMARY

Now more than ever, consumers and customers need to know they can trust the information being conveyed about an item, person, or location with which they interact. Further, employers need to know that the services performed by employees, especially gig employees, are being performed the right way, following protocols, and maintaining the company brand.

For example, in a contagion-pandemic or post-pandemic era, for instance, there is an increasing need for customers and employees to trust that the business they interact with is clean and in compliance with applicable health and safety guidelines.

According to one embodiment, for example, the present system is designed to reassure consumers that the locations they patronize are doing their best to deliver on promises and comply with the health and safety guidelines. This reassurance results from transparency in approach, execution, and follow-through.

Embodiments of the present invention address the above needs and/or achieve other advantages by providing systems and methods for using image analysis and artificial intelligence to provide real-time third party verification of compliance with the health and safety guidelines.

The system described herein may include at least one team device (e.g., smart phone, digital tablet, or any other portable wireless mobile device) in communication with one or more network devices such as a server (e.g., Confidence Cloud™) over a network (Internet), a smart display module (e.g., Confidence Smart Display™) in communication with the server over a network (Internet), and a consumer or community device (e.g., personal computer, smart phone, digital tablet, portable wireless mobile device) (“Community of Confidence™”) in communication with the server over the network. In various embodiments, the team device may be configured to access the server via a client-side application, such as, a mobile application (e.g., a Confidence® application) and/or a web interface such as a web browser. Communication between the team device, the server, the smart display module, and the consumer device is facilitated by the network, which in various embodiments may include any combination of one or more public, private, wired, and/or wireless networks, such as the Internet or a cellular network. The team device may be configured to display all tasks (for example, cleaning and disinfecting tasks within a particular business location) required for compliance with health and safety guidelines via the Confidence® application. The server may include an artificial intelligence engine and is configured to process requests made from the Confidence® application running on the team device. The server is further configured to confirm authenticity of data (for example, images of the particular business location that have been cleaned as per the tasks) received from the Confidence® application running on the team device, and send updates to the smart display module, which may be installed on a premise within the particular business location (e.g., a wall of a restaurant). The smart display module is configured to receive the updates from the server, and display information (for example, a message that the particular business location has been cleaned and sanitized). According to another embodiment, the smart display module is not required. The information otherwise displayed on the smart display module may be displayed on a customer's mobile device or website, e.g., customer may be end user, client, etc.

In an embodiment, a method may include presenting, by a server, on a user device operated by a user via a software application running on the user device, one or more tasks to be executed in a designated physical location; receiving, by the server from the user device via the software application, a set of images of the designated physical location upon execution of the one or more tasks; executing, by the server, an artificial intelligence model to process the set of images to determine whether the one or more tasks are successfully completed; and in response to determining that the one or more tasks are successfully completed, transmitting, by the server, a notification to a smart display device within the designated physical location, wherein the smart display device is configured to present the notification.

In another embodiment, a system may include a server configured to present on a user device operated by a user via a software application running on the user device, one or more tasks to be executed in a designated physical location; receive from the user device via the software application, a set of images of the designated physical location upon execution of the one or more tasks; execute an artificial intelligence model to process the set of images to determine whether the one or more tasks are successfully completed; and in response to determining that the one or more tasks are successfully completed, transmit a notification to a smart display device within the designated physical location, wherein the smart display device is configured to present the notification.

In another embodiment, a notification is transmitted to a webpage accessible by a barcode or QR code displayed in the location, e.g., on a table top, wall, checkout counter, etc.

It is to be understood that both the foregoing general description and the following detailed description are exemplary and explanatory and are intended to provide further explanation of the subject matter as claimed.

### BRIEF DESCRIPTION OF THE DRAWINGS

The accompanying drawings constitute a part of this specification and illustrate embodiments that, together with the specification, explain the subject matter.

FIG. 1 shows various components of a system for ensuring compliance with health and safety guidelines, according to an embodiment.

FIG. 2A shows a user interface of a user device displaying a page of a Confidence application, according to an embodiment.

FIG. 2B shows a user interface of a user device displaying a page of a Confidence® application, according to an embodiment.

FIG. 2C shows a user interface of a user device displaying a page of a Confidence® application, according to an embodiment.

FIG. 2D shows a user interface of a user device displaying a page of a Confidence® application, according to an embodiment.

FIG. 2E shows a user interface of a user device displaying a page of a Confidence® application, according to an embodiment.

FIG. 3 shows a smart display device presenting a notification associated with compliance with health and safety guidelines, according to an embodiment.

FIG. 4 shows a smart display device within a restaurant, according to an embodiment.

FIG. 5 shows a smart display device within a parking garage, according to an embodiment.

FIG. 6 shows a smart display device within a school, according to an embodiment.

FIG. 7 shows integration of a smart display device with one or more peripheral devices, according to an embodiment.

FIG. 8 shows a process for ensuring compliance with health and safety guidelines, according to an embodiment.

### DETAILED DESCRIPTION

The following detailed description is provided with reference to the figures. Exemplary embodiments are described to illustrate the disclosure, not to limit its scope, which is defined by the claims. Those of ordinary skill in the art will recognize a number of equivalent variations in the description that follows without departing from the scope and spirit of the disclosure.

Non-Limiting Definitions

Definitions of one or more terms that will be used in this disclosure are described below without limitations. For a person skilled in the art, it is understood that the definitions are provided just for the sake of clarity and are intended to include more examples than just provided in the detailed description.

“Artificial Intelligence” is used in the present disclosure within the context of its broadest definition. The capability of a machine to imitate intelligent human behavior.

A “cleaning task” or “cleaning,” including all its variations, are used interchangeably in the present disclosure within the context of its broadest definition. The cleaning may refer to an act, task, or state directed towards (1) the prevention of spread of infections or diseases, (2) dust control, (3) preservation of fabrics, fixtures, fittings, furnishings, or similar, (4) a provision of an environment acceptable for intended use in various settings such as social or business settings, and/or (5) safety.

A “designated physical location” is used in the present disclosure within the context of its broadest definition. The designated physical location may refer to an indoor location or a section proximate thereto within a physical space represented by or indicative of a geographical location. In some cases, the designated physical location may represent a sub-location within a predefined proximity of the geographical location.

A “cleaning frequency” is used in the present disclosure within the context of its broadest definition. The cleaning frequency may refer to the number of times the designated cleaning location is cleaned within a predefined period.

A “cleaning schedule” is used in the present disclosure within the context of its broadest definition. The cleaning schedule may refer to a set of at least one cleaning task and a maximum duration associated therewith for completing that cleaning task within a preset period. In some cases, the cleaning schedule may include only a maximum duration available for cleaning the designated physical location, or a portion thereof, within the preset period. In some other cases, the preset period may be defined by set clock times.

A “cleaning quality” is used in the present disclosure within the context of its broadest definition. The cleaning quality may refer to a degree of cleanliness including spatial organization achieved upon completion of a single cleaning task or a set of cleaning tasks. The degree of cleanliness may be related to, without limitation, (1) the cleaning frequency; (2) the cleaning task repetition; (3) a skill, experience, or performance of the cleaning entity, (4) the cleaning task, (5) an inspection of (a) the cleaning task, or an outcome thereof, and/or (b) the designated cleaning location; (6) a type of the cleaning entity, or technologies involved therewith; (7) an intended use of the designated cleaning location or any locations proximate thereto; (8) the cleaning schedule; (9) time-bound cleaning obligations or expectations; (9) socio-economic factors related to the designated physical location or a location proximate thereto (e.g., type and frequency of use, brand value, a number of simultaneous users, etc.).

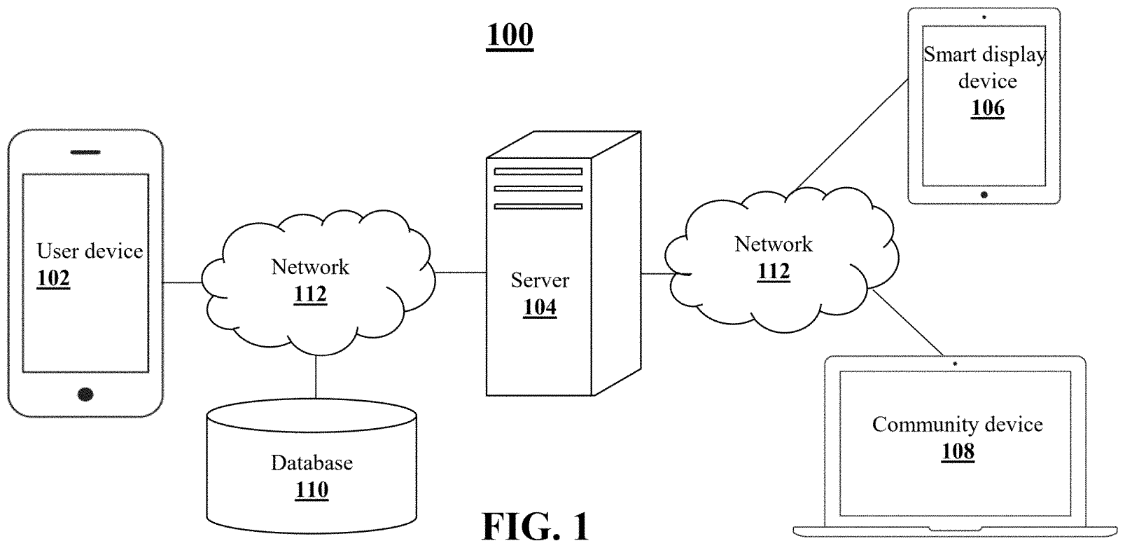

FIG. 1 shows various components of a system 100. The system 100 may include a user device 102, a server 104, a smart display device 106, a community device 108, and a database 110. The user device 102, the server 104, the smart display device 106, the community device 108, and the database 110 may communicate with each other via a network 112. The network 112 may include, but is not limited to, a private local area network, a public local area network, a wireless local area network, a metropolitan area network, a wide-area network, and Internet. The network 112 may further include both wired and wireless communications, according to one or more standards, via one or more transport mediums. The communication over the network 112 is in accordance with various communication protocols, such as a transmission control protocol and an internet protocol, a user datagram protocol, and an institute of electrical and electronics engineers communication protocols. The network 112 may further include wireless communications, according to Bluetooth specification sets, or another standard or proprietary wireless communication protocol. The network 112 may further include communications over a cellular network, including, for example, a global system for mobile communications, code division multiple access, and enhanced data for global evolution network.

The system 100 is described in a context of computer-executable instructions, such as program modules, being executed by server computers, such as the server 104. The server 104 may operate a Confidence® application (for example, a hygiene and safety software application). The user device 102 may execute the Confidence® application. The Confidence® application may include programs, objects, components, data structures, etc., which may present particular tasks (for example, cleaning tasks and sanitization tasks) based on information (for example, tables and chairs) associated with a designated physical location (for example, a restaurant) on the user device 102. The features of the system 100 may be practiced either in a single computing device, or in a distributed computing environment, where the tasks are performed by processing devices, such as the user device 102, which is linked through the network 112. In a distributed computing environment, the various program modules may be located in both local and remote computer storage media including memory storage devices.

The system 100 may operate in a local computing environment where the user device 102 operated by a user (for example, a team leader and/or a team member working in the restaurant) may execute various tasks presented via the Confidence® application running on the user device 102. The tasks may be associated with cleaning and disinfecting various objects (for example, tables, chairs, floor, door handles, etc.) within the designated physical location (for example, the restaurant). The database 110 and application programs associated with the user device 102 may be stored and executed on local computing resources. The database 110 may store information associated with the tasks (for example, type of the tasks) and results (for example, images of the objects that have been cleaned, time/date of cleaning process, materials used for cleaning, etc.) of the tasks executed by the user device 102. The server 104 may locally query the database 110 or the user device 102 to retrieve the results of executed tasks. The server 104 may execute an artificial intelligence model to process the images and verify the results of the executed tasks. In response to the execution of the artificial intelligence model, when the server 104 may determine that the results are authentic (for example, when cleaning frequency, cleaning schedule, and cleaning quality within the designated physical location based on analysis of the images may ensure proper compliance with the health and safety guidelines), the smart display device 106 located within the designated physical location may receive a notification from the server 102, and the notification is presented on an interactive graphical user interface of the smart display device 106. The notification may indicate that the objects within the designated physical location have been properly cleaned and sanitized as per the required health and safety guidelines.

The system 100 may operate in a cloud-computing environment where the user device 102 operated by the user may be cloud-optimized. The user device 102 may execute the Confidence® application, and the user may access the tasks via the Confidence® application. A remote cloud-based server 104 may store and execute data and application programs associated with the Confidence® application and the user device 102. In the cloud-computing environment, a web browser on the user device 102 may interface with an application program corresponding to the Confidence® application. Utilizing the web browser executing on the user device 102, the user may access the tasks. The user device 102 may execute the tasks. The remote cloud-based server 104 may receive the results (for example, images of the objects that have been cleaned, time/date of cleaning process, materials used for cleaning, etc.) of executed tasks from the user device 102. The remote cloud-based server 104 may execute the artificial intelligence model to verify the results of the executed tasks. In response to the execution of the artificial intelligence model, when the remote cloud-based server 104 may determine that the results are authentic (for example, when cleaning frequency, cleaning schedule, and cleaning quality within the designated physical location based on analysis of the images may ensure proper compliance with the health and safety guidelines), the smart display device 106 located within the designated physical location may receive the notification from the remote cloud-based server 102, and the notification is then presented on the interactive graphical user interface of the smart display device 106. The notification may indicate that the objects within the designated physical location have been properly cleaned and sanitized as per the required health and safety guidelines.

A user device 102 is a portable or a non-portable computing device that performs operations according to programming instructions. The user device 102 may execute algorithms or computer executable program instructions. A single processor or multiple processors in a distributed configuration of the user device 102 may execute the algorithms or the computer executable program instructions. The user device 102 may interact with one or more software modules of a same or a different type operating within the system 100.

The user device 102 may include a processor or a microprocessor for performing computations for carrying the functions of the user device 102. Non-limiting examples of the processor may include, but not limited to, a microprocessor, an application specific integrated circuit, and a field programmable object array, among others. The processor may include a graphics processing unit specialized for rendering and generating computer-generated graphics. Non-limiting examples of the user device 102 may include, but are not limited to, a cellular phone, a tablet computer, a head-mounted display, smart glasses, wearable computer glasses, a personal data assistant, a virtual reality device, an augmented reality device, or a personal computer.

The user device 102 may include an operating system for managing various resources of the user device 102. An application-programming interface associated with the operating system may allow various application programs to access various services offered by the operating system. For example, the application-programming interface may set up wired or wireless connections to the server 104, the smart display device 106, and the community device 108. As a result, the user device 102 is capable of communicating with the server 104, the smart display device 106, and the community device 108 through the network 112 using wired or wireless communication capabilities.

The user device 102 may include the Confidence® application, which may be a mobile application. The Confidence® application may be installed, integrated, or operatively associated with the user device 102. The Confidence® application may be configured to, at least one of, (1) communicate with one or more software applications, storage devices, or appliances to send and receive a variety of data; (2) collect, define, store, and analyze the data; (3) formulate one or more tasks for being performed on or trained from the data; (4) provide, execute, communicate, and/or assist in formulating one or more mathematical models for tasks related to collection, identification, manipulation, and/or presentation of the data; (5) display, print, or communicate the data; and (6) transfer the data to one or more networked computing devices. The data may include information associated with one or more tasks (for example, cleaning of objects in a restaurant). The data may be results (for example, images of cleaned objects) obtained upon execution of the one or more tasks.

The user device 102 may include the Confidence® application, which may include a template library database and engine, wherein the user can use or create templates that have a predefined process, e.g., ISO 9000, OSHA, CDC Guideline, Health Department, Automotive, Electrical, Mechanical, Industrial Machine, Warranty, Janitorial, Medical, Custom, etc. to view the tasks. The templates may be public templates (available for free or purchase by other locations), private templates (not available for inspection, use, or purchase from other locations), or combination thereof. The templates may be sorted according to sorting parameters such as industry, location, company size, company name, or some other and possibly proprietary sorting algorithm. The user may be provided an option to search the set of templates using keywords or search queries.

The user device 102 may implement the Confidence® application. The implementation of the Confidence® application may be as a computer program product, stored in non-transitory storage medium, when executed on the processor of the user device 102. The Confidence® application may be a software stack running on the operating system of the user device 102. The Confidence® application may have a protocol layer and a user interface layer where each layer may be responsible for specific jobs and functions. The protocol layer may communicate with the operating system, and manages various connections of the user device 102 over the network 112. The protocol layer may communicate with the user interface layer. The protocol layer may control the user interface layer to present the tasks (for example, cleaning various objects within the designated physical location) to the user (for example, the team member) via a user interface of the Confidence® application, and to receive information and inputs (for example, text data and images of the cleaned objects) from the user via the user interface of the Confidence® application.

The user device 102 may include a web browser. The web browser may access and present a Confidence® web application. The user device 102 may execute the Confidence® web application, and then allow the user to view the tasks (for example, cleaning various objects within the designated physical location) using the Confidence® web application. The user device 102 may execute the Confidence® web application outside of the web browser, for example, an operating system-specific image personalization software that accesses and presents the tasks based on a number of objects and different types of objects within the designated physical location.

The user device 102 may include an imaging equipment, such as one or more cameras. The imaging equipment may capture images and videos of the objects within the designated physical location while the user device 102 is executing the tasks associated with the cleaning of the objects. The imaging equipment may capture the images and the videos of the objects within the designated physical location after the user device 102 has finished execution of all the tasks associated with the cleaning of the objects.

The user device 102 may generate electronic files containing a stream of images and videos of the cleaned objects within the designated physical location, which may be stored in a local memory of the user device 102. A display screen of the user device 102 may display the electronic files. The display screen of the user device 102 may be a light emitting display for presentation of the electronic files in an interactive and a visual form. The display screen of the user device 102 may include a head-mounted display system for optically presenting information of the electronic files 116 into the eyes of the user through a virtual retinal display.

The user device 102 may transmit the electronic files to the server 104 via the Confidence® application being executed on the user device 102. The user device 102 may transmit the electronic files to the server 104 while the user device 102 is still executing the tasks. The user device 102 may transmit the electronic files to the server 104 when the user device 102 has finished executing all the tasks. The server 104 may execute one or more artificial intelligence models, which may scan and process the images and the videos in the electronic files to determine whether the various objects shown within the images and the videos are properly cleaned or not as required by the various tasks.

The user device 102 may include the Confidence® application, which may include various image-processing algorithms. The Confidence® application may be directly or indirectly associated with the various image-processing algorithms. The image-processing algorithms may include a video scanning algorithm, a video editing algorithm, an image editing algorithm, and an image scanning algorithm. The image-processing algorithms may be machine learning algorithms. The image-processing algorithms may continuously scan and process various images and videos in the electronic files captured and presented on the user device 102. The image-processing algorithms may scan and process the images and the videos in the electronic files to determine whether the various objects shown within the images and the videos are properly cleaned or not as required by the various tasks. The user device 102 may transmit results of the scanning process of the images and the videos in the electronic files to the server 104 via the Confidence® application being executed on the user device 102. The server 104 may further review the received results to confirm whether the various objects shown within the images and the videos are properly cleaned or not as required by the various tasks.

A server 104 may be a computing device comprising a processing unit. The processing unit may include a processor with a computer-readable medium, such as a random access memory coupled to the processor. The server 104 may be running algorithms or computer executable program instructions. A single processor or multiple processors in a distributed configuration of the server 104 may execute the algorithms or the computer executable program instructions. The server 104 may interact with one or more software modules of a same or a different type operating within the system 100. Non-limiting examples of the processor may include a microprocessor, an application specific integrated circuit, and a field programmable object array, among others. Non-limiting examples of the server 104 may include a server computer, a workstation computer, a tablet device, and a mobile device (e.g., smartphone).

The server 104 is associated with the user device 102, the smart display device 106, the community device 108, and the database 110 via the network 112. The server 104 may determine and transmit the tasks to the user device 102 based on a user profile, and the tasks may be presented on the Confidence® application running on the user device 102. The server 104 may receive the electronic files from the user device 102 after the user of the user device 102 may execute all the tasks presented on the Confidence® application running on the user device 102. In some embodiments, the server 104 may receive the electronic files directly from the Confidence® application executed on the user device 102 after the user of the user device 102 may execute all the tasks presented on the user device 102.

The server 104 may obtain the user profile of the user from the database 110. The user profile may include information associated with the designated physical location where the user is working, and various objects present within the designated physical location. The user profile may further include information associated with health and safety guidelines to be followed at the designated physical location. The user profile may further include the information associated with a name of the user, an age of the user, a gender of the user, hobbies of the user, personal interests of the user, occupation of the user, habits of the user, qualification of the user, preferences of the user, and social networking accounts of the user. The user profile may update automatically upon any change in the cleaning activity at the designated physical location and other activity of the user.

The server 104 may require user authentication based upon a set of user authorization credentials (e.g., username, password, biometrics, cryptographic certificate) when the user may access the Confidence® application running on the user device 102. In such implementations, the server 104 may access a memory configured to store user credentials. The server 104 may reference the memory in order to determine whether a set of entered credentials on the Confidence® application running on the user device 102 purportedly authenticating the user may match an appropriate set of credentials that identify and authenticate the user. In some implementations, upon successful authentication of the user, the server 104 may generate and serve webpages associated with the Confidence® application on the user device 102 to present a number of cleaning tasks associated with the designated physical location based upon the information within the user profile and structure of a specialized graphical user interface of the user device 102.

The server 104 may receive the electronic files from the user device 102 and execute image-feature algorithms on the various images in the electronic files to identify each object within the images. The server 104 may execute the image-feature algorithms to determine a position and an orientation of each object within the images. The server 104 may execute the image-feature algorithms in different modes. In one mode, the image-feature algorithms may be configured for approximate determination of the position, the size, and the orientation of each identified object. In another mode, the image-feature algorithms may be configured for accurate determination of the position, the size, and the orientation of each identified object. The server 104 may store the determined information associated with the position, the size, and the orientation of each object in the database 110.

The server 104 may execute the artificial intelligence models using the various images in the electronic files as an input. The server 104 may execute the image-processing algorithms, which may be machine learning algorithms on the various images in the electronic files. The execution of the models and the algorithms on the various images in the electronic files may result in extraction of features associated with the various objects in each image. The server 104 may match the extracted features associated with the various objects in each image with one or more predetermined features associated with one or more corresponding predetermined objects stored in the database 110. When the extracted features associated with the various objects in each image may match with the one or more predetermined features associated with the one or more corresponding predetermined objects stored in the database 110, the server 104 may confirm that the various objects in each image are correctly and timely cleaned and disinfected as required by the tasks. The server 104 may then generate and transmit a notification to the smart display device 106 and/or the community device 108.

A smart display device 106 may be configured to display real-time certification status of the designated physical location. For example, participating companies may display the smart display device 106 prominently so their consumers and customers know that the designated physical location is meeting its cleaning objectives as per health and safety guidelines

The smart display device 106 may be a presentation unit comprising a processing unit. The processing unit may include a processor with a computer-readable medium, such as a random access memory coupled to the processor. The smart display device 106 may be running algorithms or computer executable program instructions. A single processor or multiple processors in a distributed configuration of the smart display device 106 may execute the algorithms or the computer executable program instructions. The smart display device 106 may interact with one or more software modules of a same or a different type operating within the system 100. Non-limiting examples of the processor may include a microprocessor, an application specific integrated circuit, and a field programmable object array, among others.

The smart display device 106 may include wall mount units, which may be used to secure the smart display device 106 on walls of the designated physical location. The smart display device 106 may include e-ink display with a reflective enhancer, which may present one or more notifications received in real time from the server 104 and/or the user device 102. The notification may indicate that the objects within the designated physical location has been timely and properly cleaned and sanitized by the user as per the tasks. The notification may further indicate cleaning materials used to clean the objects within the designated physical location. The notification may further include information, such as, name of the user who cleaned the objects within the designated physical location. The notification may further include information, such as, time and date when the objects within the designated physical location were last cleaned. The notification may further include information, such as, upcoming cleaning schedule for cleaning the objects within the designated physical location.

A community device 108 is a portable or a non-portable computing device used by one or more customers and consumers that performs operations according to programming instructions. The community device 108 may execute algorithms or computer executable program instructions. A single processor or multiple processors in a distributed configuration of the community device 108 may execute the algorithms or the computer executable program instructions. The community device 108 may interact with one or more software modules of a same or a different type operating within the system 100.

The community device 108 may include a processor or a microprocessor for performing computations for carrying the functions of the community device 108. Non-limiting examples of the processor may include, but not limited to, a microprocessor, an application specific integrated circuit, and a field programmable object array, among others. The processor may include a graphics processing unit specialized for rendering and generating computer-generated graphics. Non-limiting examples of the community device 108 may include, but are not limited to, a cellular phone, a tablet computer, or a personal computer.

The community device 108 may include an operating system for managing various resources of the community device 108. An application-programming interface associated with the operating system may allow various application programs to access various services offered by the operating system. For example, the application-programming interface may set up wired or wireless connections to the server 104, the smart display device 106, and the user device 102. As a result, the community device 108 is capable of communicating with the server 104, the smart display device 106, and the user device 102 through the network 112 using wired or wireless communication capabilities.

The community device 108 may include a community software application, which may be configured to receive messages associated with the designated physical location. The community device 108 may be configured to send private messages to the server 104, e.g., “the floors are dirty.” This configuration allows the user to take corrective action without negative publicity. The community software application may be installed, integrated, or operatively associated with the community device 108. The community software application may receive the notifications in real time from the server 104. The notification may indicate that the objects within the designated physical location has been cleaned and sanitized by the user as per the tasks. The notification may further indicate cleaning materials used to clean the objects within the designated physical location. The notification may further include information, such as, name of the user who cleaned the objects within the designated physical location. The notification may further include information, such as, time and date when the objects within the designated physical location were last cleaned. The notification may further include information, such as, upcoming cleaning schedule for cleaning the objects within the designated physical location.

A database 110 associated the server 104 and the user device 102 is capable of storing data in plain format and encrypted version. The data may include information associated with the user profile, the objects, and the electronic files. The database 110 may be in communication with a processor of the server 104 and the user device 102. The processor is capable of executing multiple commands of the system 100. The database 110 may be part of the server 104 and/or the user device 102. The database 110 may be a separate component in communication with the server 104 and/or the user device 102. The database 110 may have a logical construct of data files, which may be stored in non-transitory machine-readable storage media, such as a hard disk or memory, controlled by software modules of a database program (e.g., SQL), and a database management system that executes the code modules (e.g., SQL scripts) for various data queries and management functions.

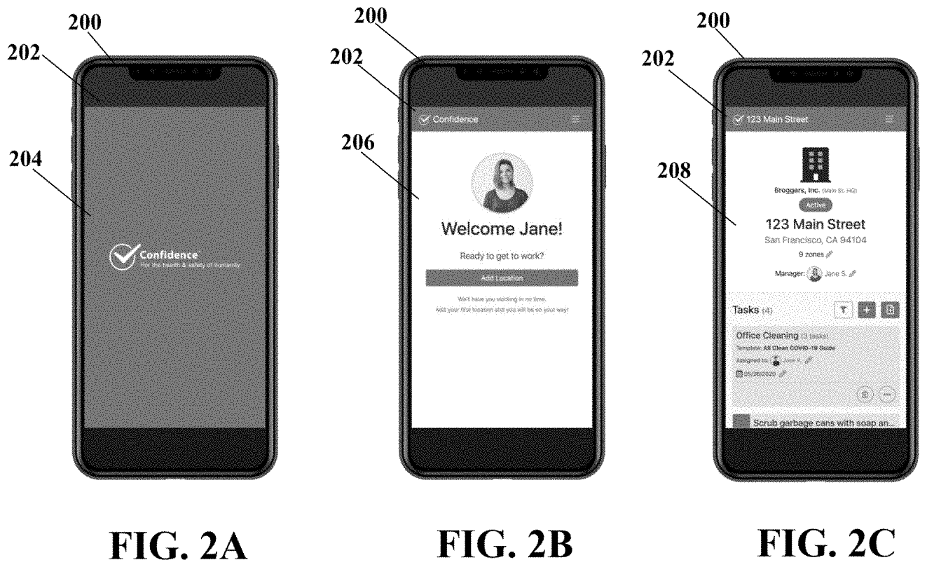

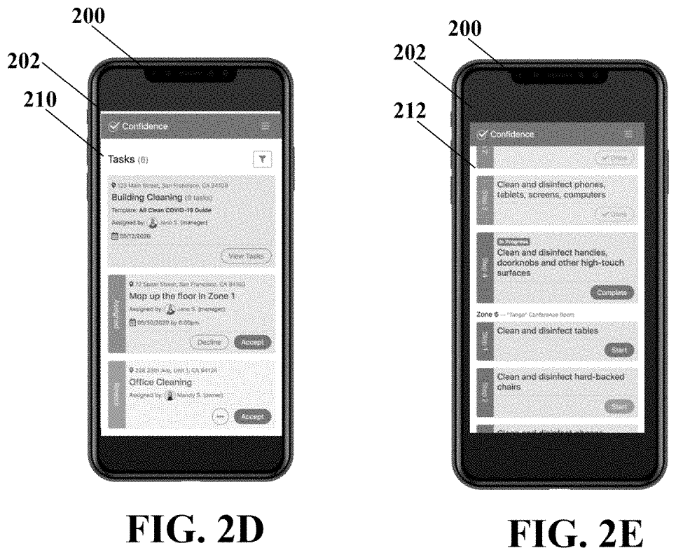

FIGS. 2A-2E show a user device 200 used by a user working in a restaurant. The user device 200 is a mobile device. Some alternate embodiments may include any other type of the user device 200. For example, the user device 200 may be a computer or a display device in form of glasses, goggles, or any other structure that supports and incorporates various components of the user device 200, as well as serves as a conduit for electrical and other component connections.

The user device 200 may include processors, transmitters, receivers, communication components, antennas, user interfaces, cameras, sensors, and input devices. The processors of the user device 200 may perform one or more operations according to one or more programming instructions. The user device 200 may further include a software product, for example, a Confidence® mobile application executed by the processors of the user device 200. The user device 200 may be capable of communicating with a server (for example, a cloud device operating the Confidence® mobile application) using wired or wireless communication capabilities. The server may be associated with the Confidence® mobile application running on the user device 200.

The user device 200 may include a display screen 202. The display screen 202 may include one or more of display components, such as a cathode ray tube, a liquid crystal display, an organic light-emitting diode display, an active matrix organic light emitting diodes display, a super-active matrix organic light emitting diodes display, a plasma display, an incandescent light, a fluorescent light, a front or a rear projection display, or a light emitting diode indicator. The display screen 202 may be connected to a processor of the user device 200 for entering data and commands in the form of text, touch input, gestures, etc.

The user device 200 may execute the Confidence® mobile application. As shown in the FIG. 2A, a home page 204 of the Confidence® mobile application may then be presented on the display screen 202. A first user may create an account in the Confidence® mobile application. The first user may be a team leader (for example, a manager) working in the restaurant. When the first user may already have the account, the first user may input login data to access the account in the Confidence® mobile application. After the first user may submit the login data in the Confidence® mobile application, as shown in the FIG. 2B, a page 206 of the Confidence® mobile application may be presented on the display screen 202 where the first user may input a location (for example, an address) of the restaurant.

The first user may create various zones (for example, zone 1 is kitchen, zone 2 is bathroom, zone 3 is storage room, etc.) of the restaurant using the Confidence® mobile application. The first user may then generate multiple tasks associated with cleaning of objects (for example, chairs, tables, computers, door handles, etc.) within various zones of the restaurant using Confidence® mobile application. As shown in the FIG. 2C, a page 208 of the Confidence® mobile application may be presented on the display screen 202 where the first user may view the one or more tasks. As shown in the FIG. 2D, a page 210 of the Confidence® mobile application may be presented on the display screen 202 where the first user may further view one or more additional tasks associated with cleaning of the objects within various zones of the restaurant. As shown in the FIG. 2E, a page 212 of the Confidence® mobile application may be presented on the display screen 202 where the user may view additional tasks associated with cleaning of the objects within various zones of the restaurant. The first user may use the Confidence® mobile application to assign the various tasks to one or more second users (for example, one or more team members, who may be employees of the restaurant). The one or more second users may be able to view the various tasks on their electronic devices via the Confidence® mobile application running on their electronic devices.

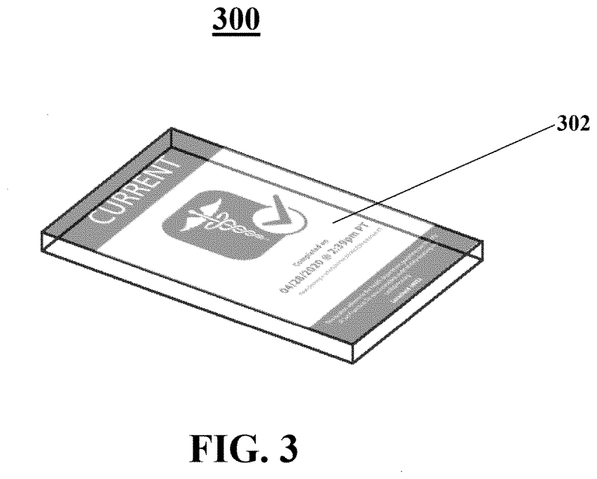

FIG. 3 shows a smart display device 300. The smart display device 300 may include a processor, a display screen, and a battery. The smart display device 300 may be in communication with a user device of a user and a server. The user may be a team leader. The user may be a team member. The user device may execute a Confidence® mobile application and the server may manage operations of the Confidence® mobile application. A user may view cleaning tasks within a business shop of the user via the Confidence® mobile application running® on the user device. The cleaning tasks may include cleaning and disinfecting objects within the business shop. The user may complete all the cleaning tasks presented on the Confidence® mobile application within a predetermined period of time. The user device may transmit results of the tasks completed by the user (for example, images of the objects that have been cleaned as per the tasks) to the server via the Confidence® mobile application. The server may execute an artificial intelligence model to process and analyze the results of the tasks received from the user device to confirm the authenticity of the results of the tasks. When the server may determine that the cleaning tasks have been completed successfully based on processing of the images using the artificial intelligence model, the server may transmit a notification to the smart display device 300. The smart display device 300 may display information 302 within the notification, which may indicate that the business shop has been timely and properly cleaned and sanitized.

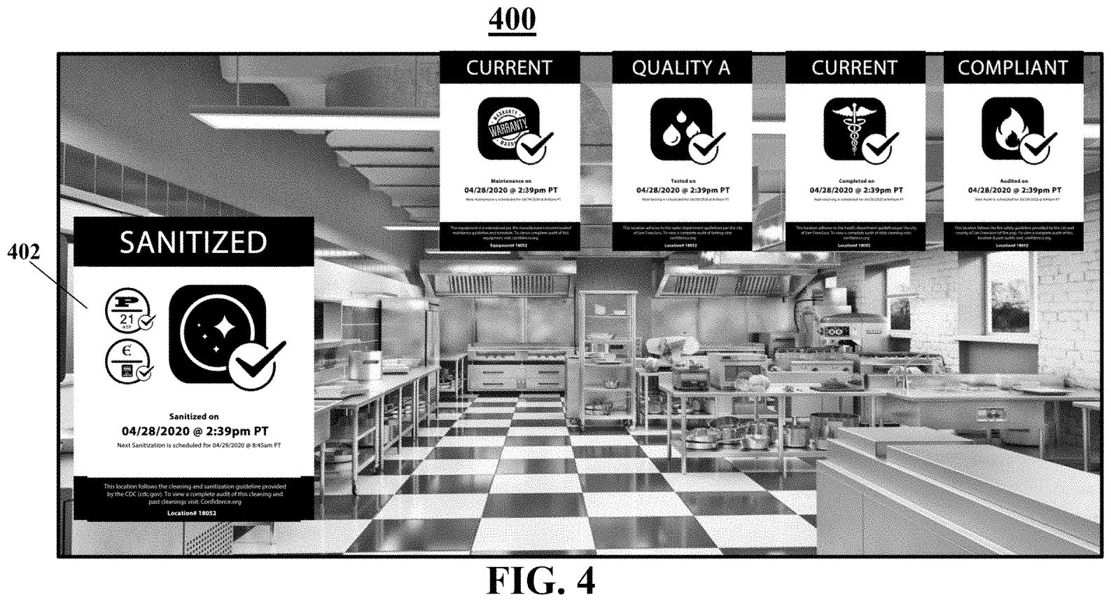

FIG. 4 shows a smart display device 402, which may be located within a restaurant 400 (for example, neighborhood pizza place). The smart display device 402 may include a processor, a display screen, and a battery. The smart display device 402 may be in communication with a user device (for example, a mobile phone) of a first user (for example, a team leader, such as a restaurant manager) working in the restaurant 400 and a server.

The restaurant 400 may use an artificial intelligence system to proactively follow health department safety guidelines, allowing the restaurant 400 to be prepared for an unscheduled visit from a health inspector. The first user working in the restaurant 400 may want to be in compliance with the health department, and in order to do so, the first user may use a Confidence® application on the user device. The first user may download and execute the Confidence® application on the user device. The first user may submit information associated with the restaurant 400, such as objects (tables and chairs) present within the restaurant 400 and a location of the restaurant 400 in the Confidence® application. The first user may select a health department template, which may include a checklist of all required tasks (for example, cleaning tasks associated with the objects) to meet the guidelines of the health department. The first user may assign the tasks to himself and/or second users (for example, team members of the first user). The first user may select a frequency (for example, every two hours) to complete each task. When the second users are selected to perform the tasks, the second users may receive a text message on their electronic device, which may include the Confidence® application. The text message presented via the Confidence® application may include information associated with the tasks and how to complete the tasks. After each task is completed by the first user and/or the second users, the first user and/or the second users may capture images of the objects using their devices that may have been cleaned as per the tasks. The first user and/or the second users may upload the images in the Confidence® application running on their devices. The Confidence® application may capture a time, a date, and a current location when the tasks have been completed and the images are uploaded.

The Confidence® application may process inputted data after the completion of the tasks to score a level of completion of the tasks using an artificial intelligence model. The first user may receive a notification on the user device via the Confidence® application when all the second users have completed the tasks and uploaded the images. The first user may review the images uploaded in the Confidence® application. The first user may approve or decline the images. When the first user may approve the images, a server operating the Confidence® application may receive and process the images. The server may execute the artificial intelligence model to process the images to determine whether the objects present within the images are cleaned or not as required by the tasks. When the server may determine that the objects have been properly and timely cleaned, the server may update the smart display device 402 displayed on a wall of the restaurant 400 with a health department approval symbol (e.g., Badge of Confidence™), along with an update in the community device for all consumers to see it. In another embodiment, the server may update a website accessible by a barcode or QR code with a health department badge of confidence, along with an update in the community device for all consumers to see it. The community device may include a public site (website) where all participating users (for example, team leaders) can share the status of their business. Historical data and events may also be available on the public site.

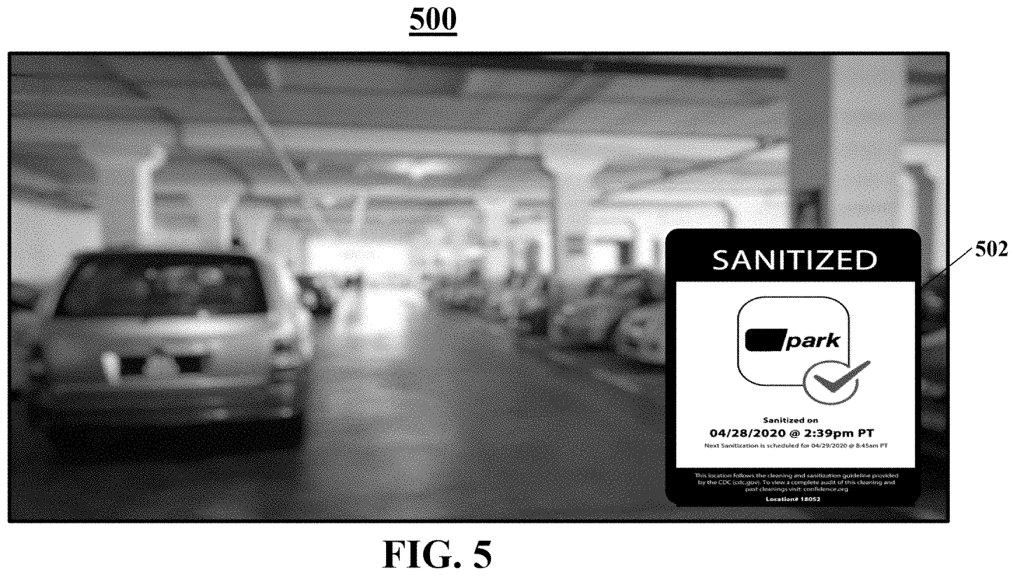

FIG. 5 shows a smart display device 502, which may be located within a parking garage 500. The smart display device 502 may include a processor, a display screen, and a battery. The smart display device 502 may be in communication with a user device of a user working in the parking garage 500 and a server. The user may be a team leader. The user may be a team member. The user device may execute a Confidence® mobile application and the server may manage operations of the Confidence® mobile application. The user may view cleaning tasks within the parking garage 500 via the Confidence® mobile application running on the user device. The cleaning tasks may include cleaning and disinfecting floors within the parking garage 500. The user may complete all the cleaning tasks presented on the Confidence® mobile application within a predetermined period of time. The user device may transmit results of the tasks (for example, images of the floors that have been cleaned as per the tasks) to the server via the Confidence® mobile application. The server may execute an artificial intelligence model to process the results of the tasks received from the user device to confirm the authenticity of the results of the tasks. When the server may determine that the cleaning tasks have been completed successfully based on processing of the images using the artificial intelligence model, the server may transmit a notification to the smart display device 502. The smart display device 502 may display the notification, which may indicate that the floors and other things within the parking garage 500 have been properly and timely cleaned and sanitized.

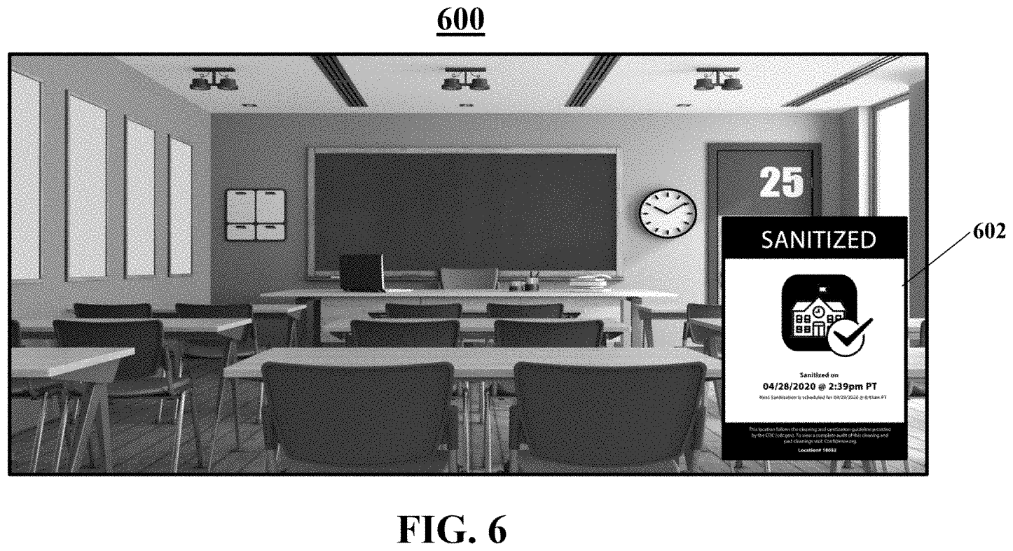

FIG. 6 shows a smart display device 602, which may be located within a school 600. The smart display device 602 may include a processor, a display screen, and a battery. The smart display device 602 may be in communication with a user device of a user working in the school 600 and a server. The user may be a team leader. The user may be a team member. The user device may execute a Confidence® mobile application and the server may manage operations of the Confidence® mobile application. The user may view cleaning tasks within the school 600 via the Confidence® mobile application running on the user device. The cleaning tasks may include cleaning and disinfecting classrooms within the school 600. The user may complete all the cleaning tasks presented on the Confidence® mobile application within a predetermined period of time. The user device may transmit results of the tasks (for example, images of the classrooms that have been cleaned as per the tasks) to the server via the Confidence® mobile application. The server may execute an artificial intelligence model to process the results of the tasks received from the user device to confirm the authenticity of the results of the tasks. When the server may determine that the cleaning tasks have been completed successfully based on processing of the images using the artificial intelligence model, the server may transmit a notification to the smart display device 602. The smart display device 602 may display the notification, which may indicate that the classrooms within the school 600 have been properly and timely cleaned and sanitized.

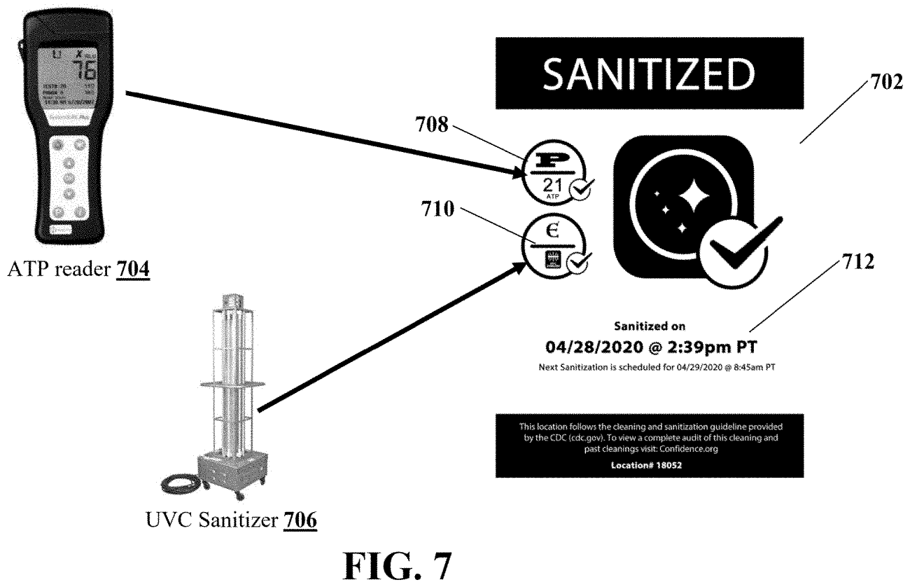

FIG. 7 shows integration of a smart display device 702 with one or more peripheral devices, such as a first peripheral device 704 and a second peripheral device 706. The first peripheral device 704 may be an adenosine triphosphate (or ATP) reader, which may be configured to measure actively growing microorganisms through detection of the ATP on surfaces. The second peripheral device 706 may be Ultraviolet C Light Sanitizer (or UVC Sanitizer), which is configured to emit light supposed to thwart pathogens like SARS-CoV-2 without harming humans.

The smart display device 702 may be associated with a user device, which may be running a Confidence® mobile application managed by a server. The first peripheral device 704 and the second peripheral device 706 may be associated with the user device through the Confidence® mobile application. The smart display device 702 may be integrated with the first peripheral device 704 and the second peripheral device 706 through an application programming interface associated with the Confidence® mobile application.

When a user operating the user device may execute the confidence mobile application on the user device, the user may view cleaning tasks within a designated physical location (for example, a shopping mall) via the Confidence® mobile application running on the user device. The cleaning tasks may include cleaning and disinfecting shops within the shopping mall. The user may complete all the cleaning tasks presented on the Confidence® mobile application within a predetermined period of time. The user may use the first peripheral device 704 and the second peripheral device 706 while completing the cleaning tasks. The user device may transmit results of the tasks (for example, images of the shops that have been cleaned as per the tasks, and information associated with the first peripheral device 704 and the second peripheral device 706 used to execute the cleaning tasks) to the server via the Confidence® mobile application. The server may execute an artificial intelligence model to process the results of the tasks received from the user device to confirm the authenticity of the results of the tasks. When the server may determine that the cleaning tasks have been completed successfully based on processing of the images using the artificial intelligence model, the server may transmit one or more notifications and messages to the smart display device 702. The smart display device 702 may display a first message 708 and a second message 710. The first message 708 may include a reading from the first peripheral device 704. The second message 710 may indicate that the second peripheral device 706 was used. The smart display device 702 may further display a notification 712, which may indicate that the shops within the shopping mall have been properly and timely cleaned and sanitized.

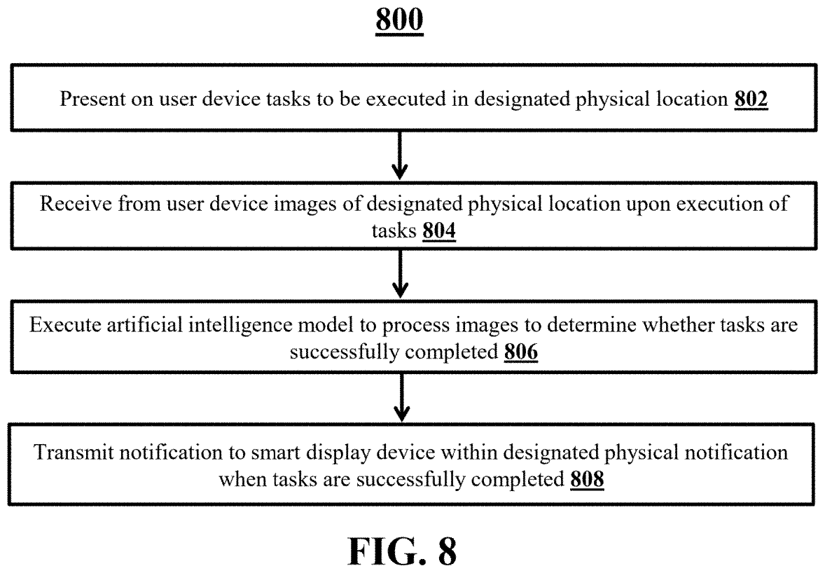

FIG. 8 shows execution steps of a method 800 for ensuring compliance with health and safety guidelines. The method 800 shown in the FIG. 8 comprises execution steps 802, 804, 806, and 808. However, it should be appreciated that other embodiments may comprise additional or alternative execution steps, or may omit one or more steps altogether. It should also be appreciated that other embodiments may perform certain execution steps in a different order; steps may also be performed simultaneously or near-simultaneously with one another. In addition, the exemplary method 800 of the FIG. 8 is described as being executed by a single server computer in this exemplary embodiment. However, one having skill in the art will appreciate that, in some embodiments, steps may be executed by any number of computing devices operating in a distributed computing environment. In some cases, a computer executing one or more steps may be programmed to execute various other, unrelated features, where such computer does not need to be operating strictly as the server computer described herein.

In a first step 802, a server may present on a user device operated by a user via a software application running on the user device, one or more tasks to be executed in a designated physical location. The server may manage the software application. The designated physical location may be a bookshop. The user may be a team member (for example, an employee of the bookshop).

Typically, a team leader (for example, a manager of the bookshop) may use an electronic device running the software application to create the one or more tasks. The one or more tasks may be associated with cleaning and disinfecting the bookshop. The one or more tasks may indicate one or more cleaning devices (for example, UV light device) to be used for cleaning and disinfecting the bookshop. The team leader may use the electronic device to transmit the one or more tasks to the user device via the software application. The user device may display the one or more tasks via the software application.

In a second step 804, the user may use the one or more cleaning devices to execute the one or more tasks. Upon finishing the one or more tasks, the user device may be used to capture a set of images of the designated physical location. The user device may tag the set of images. For example, the user device may tag a table shown in the set of images as “cleaned.” The set of images may be uploaded in the software application. The server may receive the set of images from the user device via the software application.

In a third step 806, the server may execute an artificial intelligence model to process the set of images to determine whether the one or more tasks are successfully completed. The artificial intelligence model may be trained with a sample set of images, which may include a plurality of items and objects (for example, chairs, door knobs, tables, desks, floor, etc.) that are cleaned as well uncleaned. During the processing of the set of images, the server may determine that one or more items (for example, tables, floor, etc.) shown within the set of images are properly cleaned or not using the one or more cleaning devices mentioned in the one or more tasks.

In step 808, the server may determine that the one or more tasks are successfully completed. The server may then generate and transmit a first notification and a second notification to a smart display device present within the designated physical location. The smart display device may display the first notification and the second notification. The first notification may indicate that the designated physical location was properly cleaned and sanitized at a particular date and time. The second notification may indicate that the one or more cleaning devices were used to clean the designated physical location. The second notification may further include readings from the one or more cleaning devices.

The server may also facilitate a mobile payment (e.g., monetary or rewards) to a user device for a completed task (or partially completed task), which can encourage compliance and improve morale, e.g., recent study found that 68% of Gen Z consumers are interested in instant person-to-person payments. Mobile payments (e.g., mobile wallets and mobile money transfers) are transactions that occur through a mobile device and can be used in person-to-person context to pay for services. A mobile wallet is basically a digital wallet on the phone wherein you can securely add, and store bank detail(s) associated with your debit or credit card(s). Mobile payments are designed to be fast (e.g., takes about a second to process), convenient, and secure (e.g., multiple layers of dynamic encryption).

The mobile payment may be in form of fiat currency, digital currency, virtual currency, cryptocurrency, and/or tokens. It may be in the form of gifts, rewards, time off, and/or recognition. It may be a combination of any of these forms of payment.

The value of the reward might be determined based on one or more of the following criteria: completion of task; score of completed task (e.g., Confidence® score); level of difficulty of completed task; historical record of user related to task completed, e.g., consistency and/or improvement, etc.

For example, a user with a connected bank account (or mobile wallet) may receive payment and/or additional rewards automatically after completing a task, e.g., staining a deck. In this example, there are 9 steps in the “Stain Deck Protocol”: 1) Gather Supplies; 2) Clear Deck; 3) Inspect Deck; 4) Clean Deck; 5) Sand Deck; 6) Select a Stain; 7) Check Weather Forecast Before Staining; 8) Apply Stain; and 9) Restain Periodically. Upon completion of step 8, the server may send payment to the user's device. If the user's score is over a certain threshold, e.g., because the stain was applied consistently across the entire surface as determined by the AI engine, then a payment algorithm may be configured to send the user additional rewards.

In this example, according to another embodiment, the system may be configured in Step 6 to suggest “best-selling” deck stains and provide links to purchase these stains, e.g., link to stain available on Home Depot® website. According to another embodiment, the system may be configured in Step 6 to recommend a type of stain that should be used based on any number of dynamic factors, including environmental conditions, other user behavior, cost, etc. According to another embodiment, the system may be configured in Step 5 to recommend gig employees available to assist with the task.

In one example, a restaurant manager may use a computer to execute a Confidence® mobile application. The restaurant manager may use the Confidence® mobile application to generate cleaning tasks within a restaurant. The cleaning tasks may include cleaning and disinfecting tables and chairs within the restaurant. A restaurant worker may use a mobile phone to execute the Confidence® mobile application. The restaurant worker may view the cleaning tasks generated by the restaurant manager via the Confidence® mobile application. The restaurant worker may complete all the cleaning tasks presented on the Confidence® mobile application within a predetermined period of time for compliance. The mobile phone may transmit results of the tasks completed by the restaurant worker to a cloud server, which may manage the Confidence® mobile application. The cloud server may process the results of the tasks received from the mobile phone using its artificial intelligence engine to confirm the authenticity of the results of the tasks. When the cloud server may determine that the cleaning tasks have been completed successfully, the cloud server may transmit a notification to a smart display device, which may be installed within the restaurant. The smart display device may display the notification, which may indicate that the restaurant has been cleaned and sanitized. The notification may further indicate type of cleaning materials used to clean the restaurant.

In another example, a coffee shop manager may use a mobile phone to execute a Confidence® mobile application. The coffee shop manager may use the Confidence® mobile application to generate cleaning tasks within a coffee shop. The cleaning tasks may include cleaning and disinfecting tables and chairs within the coffee shop. A coffee shop worker may use a computer to execute the Confidence® web application. The coffee shop worker may view the cleaning tasks generated by the coffee shop manager within the coffee shop via the Confidence® web application. The coffee shop worker may complete all the cleaning tasks presented on the Confidence® web application within a predetermined period of time for compliance. A cloud server, which may manage the Confidence® web application may extract results of the cleaning tasks from the Confidence® web application running on the computer. The cloud server may process the results of the tasks using its artificial intelligence engine to confirm the authenticity of the results of the tasks. When the cloud server may determine that the cleaning tasks have been completed successfully, the cloud server may transmit a notification to a community device, which may be accessible to one or more customers of the coffee shop. The community device may display the notification, which may indicate that the coffee shop has been cleaned and sanitized. The notification may further indicate a type of cleaning materials used to clean the coffee shop.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
presenting, by a server, on a user device operated by a user via a software application running on the user device, one or more tasks to be executed in a designated physical location;
receiving, by the server from the user device via the software application, a set of images of the designated physical location upon execution of the one or more tasks;
executing, by the server, an artificial intelligence model to process the set of images to determine whether the one or more tasks are successfully completed; and
in response to determining that the one or more tasks are successfully completed, transmitting, by the server, a notification to a smart display device within the designated physical location, wherein the smart display device is configured to present the notification.

2. A system comprising:
a server configured to:
present on a user device operated by a user via a software application running on the user device, one or more tasks to be executed in a designated physical location;
receive from the user device via the software application, a set of images of the designated physical location upon execution of the one or more tasks;
execute an artificial intelligence model to process the set of images to determine whether the one or more tasks are successfully completed; and
in response to determining that the one or more tasks are successfully completed, transmit a notification to a smart display device within the designated physical location, wherein the smart display device is configured to present the notification.
